(19) United States
(12) Patent Application Publication
(10) Pub. No.: US 2003/0141816 A1
(43) Pub. Date: Jul. 31, 2003

(54) Plasma display panel and method for fabricating thereof

(76) Inventor: Jong-Rae Lim, Seoul (KR)

Correspondence Address: BIRCH STEWART KOLASCH & BIRCH, PO BOX 747, FALLS CHURCH, VA, 22040-0747, US

(21) Appl. No.: 10/337,286

(22) Filed: Jan. 7, 2003

(30) Foreign Application Priority Data
Jan. 31, 2002 (KR) 05661/2002

(51) Int. Cl. H01J 17/49

(52) U.S. Cl. 313/586

(57) ABSTRACT

A plasma display panel and a method for fabricating thereof, capable of preventing damage of a sustain electrode and uniformizing a thickness of a dielectric layer, including the steps of forming a predetermined photoresist pattern on an upper glass substrate, forming a groove on the upper glass substrate by the photoresist pattern, forming bus electrodes to be inserted in the groove formed on the upper glass substrate, forming a sustain electrode which is formed to cover the bus electrodes, for causing discharging, forming a dielectric layer on the front surface of the upper glass substrate and forming a protection layer on the dielectric layer, can reduce thickness of the dielectric layer, thus to improve transmissivity, reduce the cost, and decrease a discharging voltage.

### BACKGROUND OF THE INVENTION

1. Field of the Invention

The present invention relates to a plasma display panel and a method for fabricating thereof and particularly, to a plasma display panel and a method for fabricating thereof, capable of preventing damage of a sustain electrode and uniformizing a thickness of a dielectric layer.

2. Description of the Background Art

Generally, as the information processing system has increasingly developed and provided, the importance of the display apparatus as a visual information transmitting means is increased. Particularly, in the conventional Cathode Ray Tube (CRT), the volume of the apparatus for displaying images is large, and distortion of image by an earth magnetic field is generated. Therefore, it does not fit for the current demands of scale-up, flatting, high luminance, and high efficiency of screens, and researches on various flat displays having a matrix structure are actively progressed.

For instance, the liquid crystal display (hereinafter, as LCD), field emission display (hereinafter, as FED), plasma display panel (hereinafter, as PDP) and the like are actively developed as the flat display apparatus.

The PDP displays images including letters or graphics by light emission by ultraviolet rays generated in discharging inert mixed gas such as He+Xe, Ne+Xe, He+Ne+Xe and the like. Such PDP can become easily thinner and larger and as the structure is simplified, fabrication is eased. Also, luminance and luminous efficiency is higher when compared with another display panels. Due to those advantages, researches on the PDP has been actively conducted. Particularly, in a 3-electrode alternating current surface discharge type PDP, since a dielectric layer covers an electrode, a wall charge is stored, and the electrodes are protected from impacts of ions generated by discharging, thus to enable low voltage driving and long life span.

FIG. 1 is a view showing the conventional 3-electrode surface discharge alternating current plasma display panel (AC PDP). FIG. 2 is a cross-sectional view showing unit discharging cells of the conventional AC PDP. As shown in FIGS. 1 and 2, the discharging cells include an upper substrate in which a sustain electrode 2 is formed and a lower substrate in which an address electrode 7 is formed. The upper and lower substrates are separated in parallel centering a barrier rib 9 therebetween.

In the discharging space which is formed by the upper and lower substrates and the barrier rib 9, discharging gas is filled. Therefore, the discharging gas emits visible rays to the outside by vacuum ultraviolet rays.

One of the pairs of the sustain electrodes 2 generates an opposite discharging together with the address electrode 7 in response to scan pulses supplied in an address period. Also, the pair of sustain electrodes 2 cause surface discharge in response to the sustain pulses supplied in a sustain period. The pair of sustain electrodes 2 used as the injection/sustain electrodes are used as common sustain electrodes to which the sustain pulses are commonly supplied.

On the upper glass substrate 1 in which a sustain electrode 2 is formed, an upper dielectric layer 4 and protection layer 5 are deposited. The upper dielectric layer 4 limits plasma discharging current and stores the wall charge in case of discharging. The protection layer 5 prevents damage of the upper dielectric layer 4 by impact of the ion generated in plasma discharging, and improves emission efficiency of the secondary electron. The address electrode 7 is formed at crossing to the sustain electrode 2, and data signals for selecting cells to be displayed are supplied. A lower dielectric layer 8 is formed in the lower glass substrate 6 in which the address electrode 7 is formed. Barrier rib 9 for dividing the discharging spaces are vertically expanded. On the surface of the lower dielectric layer 8 and barrier rib 9, fluorescent substance 10 which is excited by vacuum ultraviolet rays, for generating visible rays corresponding to R, G and B colors is applied.

The PDP discharging cell with the above structure is selected by opposite discharging between the address electrode 7 and sustain electrode 2, and maintains the discharged state by surface discharging between the pair of sustain electrodes. The fluorescent substance 10 emits light by ultraviolet rays generated in case of sustain discharging and accordingly, the visible rays are emitted to the outside of the cell. By adjusting such discharging maintaining period of the cell, that is, the number of times of the sustain discharging, a gray scale which is necessary for image display can be embodied.

Also, the sustain electrode 2 is formed on the upper glass substrate 1 by a sputtering or vacuum deposition method, and a metal bus electrode 3 made of Cr/Cu/Cr or Ag is formed on the sustain electrode 2 mainly by the sputtering method. The upper dielectric layer 4 which is applied to the upper glass substrate 1 in which the sustain electrode 2 and bus electrode 3 are formed is applied by a screen printing method, and the protection layer 5 is formed on the surface of the dielectric layer 4.

However, if the voltage difference between the pair of sustain electrodes 2 is large, the pair of sustain electrodes 2 were damaged by electro migration. Accordingly, transmissivity of the upper plate of the PDP was degraded.

For instance, the electro migration can be described with reference to chemical formulas 1 to 5.

The two electrodes (that is, the pair of sustain electrodes) includes Ag, and when a potential difference is generated between the pads of the two electrodes, the pads of the two electrodes respectively become a cathode (negative pole) and anode (positive pole). That is, as shown in Formula 4, the positive ions of Ag are eluted in the cathode and move to the anode under the condition of dissolved oxygen, and a reduction reaction is occurred as shown in Formula 1, thus to deposit Ag on the anode.

Formulas 2 and 3 show a rate-determining step for determining a rate of migration generation. That is, Formula 2 shows a reduction of the dissolved oxygen and Formula 3 shows electrolysis and hydrogen generating reaction. At this time, when the voltage difference among pads of the two electrodes becomes larger by the increase of the applied voltage, the current is increased and generation of migration is facilitated accordingly. In other words, when the applied voltage is raised, the current by the eluent solution of Ag is increased in the anode by increasing the current of the cathode by Formulas 2 and 3 which show an initial reaction of the cathode. Namely, when oxygen is generated by the electrolysis of Formula 5 among the pads of the two electrodes, Ag⁺ ions of Ag which exist in the anode move to the cathode, and accordingly reactions of Formula 2 and 3 are occurred on the surface of the cathode. Then, the Ag⁺ ions are combined with OH⁻ ions and dispersed in a collided shape of AgOH, Ag, Ag₂O compounds on the surface of the cathode. As the result, if the potential difference among the pads of the two electrodes becomes larger, discoloration of the surface is occurred and electrode opening is occurred in the two adjacent pads or shorts are generated between the two pads.

Ag⁺+E⁻→Ag (1)

O₂+2H₂O+4e⁻→4OH⁻ (2)

2H₂O+2e⁻→40H⁻ (3)

Ag→Ag⁺+e⁻ (4)

H₂O→½O₂+2H⁺+2e⁻ (5)

Therefore, since the dielectric layer for preventing Ag diffusion in case of forming an upper dielectric layer to prevent the electro migration, the corresponding processes became complicated.

Also, since the thickness of the upper dielectric layer 4 was not uniformly formed due to a thickness step of the sustain electrode 2 and bus electrode 3, breakdown that the current is rapidly increased could be easily generated. Therefore, the thickness of the upper dielectric layer 4 should be increased.

### SUMMARY OF THE INVENTION

Therefore, an object of the present invention is to provide a plasma display panel and a method for fabricating thereof, capable of preventing damage of a sustain electrode by forming a bus electrode on an upper glass substrate and uniformizing a thickness of a dielectric layer.

To achieve these and other advantages and in accordance with the purpose of the present invention, as embodied and broadly described herein, there is provided a plasma display panel comprising an upper glass substrate which has two grooves in each discharging cell and bus electrodes are inserted in the grooves.

To achieve these and other advantages and in accordance with the purpose of the present invention, as embodied and broadly described herein, there is provided a method for fabricating a plasma display panel, including the steps of forming a predetermined photoresist pattern on an upper glass substrate, forming a groove on the upper glass substrate by the photoresist pattern, forming bus electrodes to be inserted in the groove formed on the upper glass substrate, forming a pair of sustain electrode which is formed to cover the bus electrodes, for causing discharging, forming a dielectric layer on the front surface of the upper glass substrate and calcining the dielectric layer, and forming a protection layer on the dielectric layer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a conventional 3-electrode surface discharge AC PDP;

FIG. 2 is a cross-sectional view showing unit discharging cells of the conventional AC PDP;

FIG. 3 is an exemplary view showing upper and lower substrates of a PDP in accordance with an embodiment of the present invention; and

FIGS. 4A to 4H are views sequentially showing a method for fabricating an upper substrate of the PDP in accordance with an embodiment of the present invention.

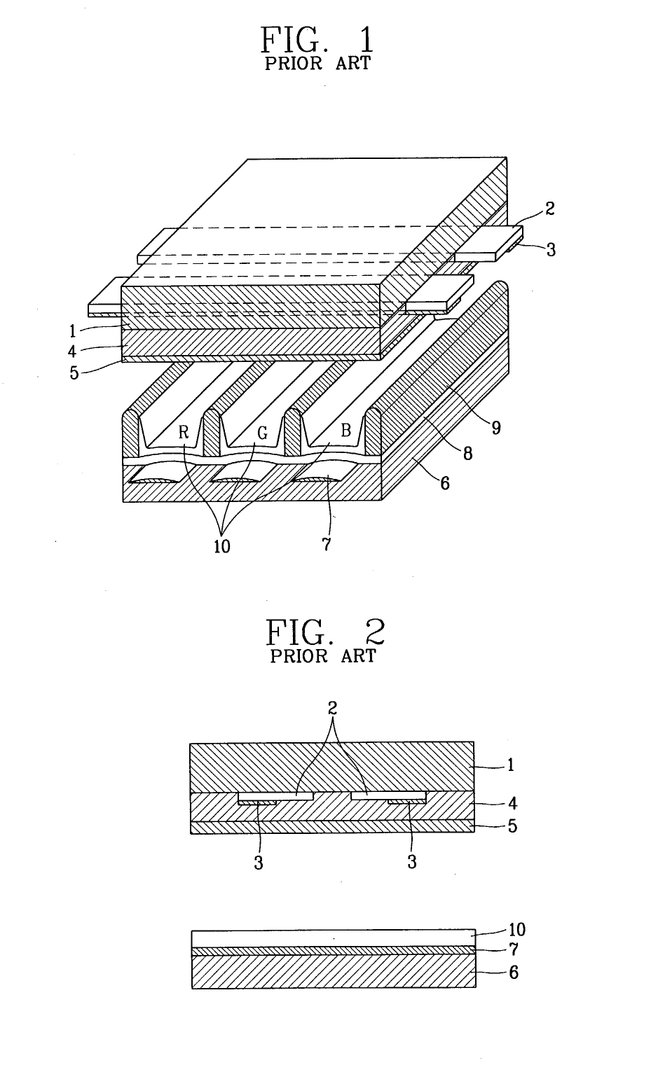

### DETAILED DESCRIPTION OF THE PREFERRED EMBODIMENTS

Reference will now be made in detail to the preferred embodiments of the present invention, examples of which are illustrated in the accompanying drawings.

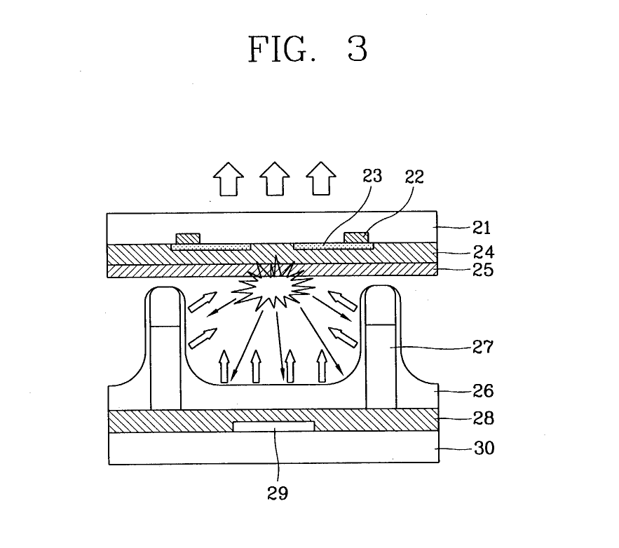

FIG. 3 is an exemplary view showing upper and lower substrates of a PDP in accordance with an embodiment of the present invention.

As shown in the drawing, an upper substrate of a PDP in accordance with the present invention includes an upper glass substrate 21 having two grooves in each unit discharging cell, bus electrodes 22 which are inserted in grooves which are formed on the upper glass substrate 21, a sustain electrode 23 which is formed with transparent conductive materials to cover the bus electrodes 22 on the upper glass substrate 21, for causing discharging, an upper dielectric layer 24 which is formed in the upper glass substrate 21 to cover the sustain electrode 23 and a protection layer 25 which is formed in the upper portion of the upper dielectric layer 24.

The structure of the upper substrate of the PDP in accordance with the present invention will be described in detail.

The upper glass substrate 21 has a structure that a groove having a thickness of 5 to 10 μm is formed in a predetermined region. The sustain electrodes 23 are formed as pairs in a pixel, and maintain luminance of a pixel in case of mutually discharging the sustain electrodes 23. Here the sustain electrode 23 is composed of Indium-Tin-Oxide, Indium-Zinc-Oxide or Indium-Tin-Zinc-Oxide in due consideration of its transmissivity. The bus electrode 22 has a relatively narrower width than the sustain electrode 23, compensates a resistance component of the sustain electrode 23, and is formed at an edge of the sustain electrode to have a long gap. Also, the bus electrode 22 is formed to be inserted in a groove formed in the upper glass substrate 21 so that it is not contacted with the dielectric layer 24, and is positioned between the upper glass substrate 21 and sustain electrode 23. Here, the bus electrodes 22 is composed of metal alloys of Cr/Cu/Cr, or Ag to compensate a high resistance of transparent substances of ITO series such as Indium-Tin-Oxide, Indium-Zinc-Oxide or lndium-Tin-Zinc-Oxide. The dielectric layer 24 containing series of SiO2 and PbO is applied to limit a current by forming natural capacitance and the sustain electrode 23 is insulated. Also, a protection layer 30 is deposited on the surface of the dielectric layer 24 with substances of MgO and the like.

Also, the composition of the lower substrate of the PDP in accordance with the present invention will be described.

The lower substrate 30 of the PDP includes an address electrode 29 which is formed on the lower glass substrate 30 at crossign to the sustain electrode 30, for supplying data signal for selecting cells to be displayed, a lower dielectric layer 28 which is formed on the upper front surface of the address electrode 29, a barrier rib 27 which is formed between the upper substrate and the lower substrate to divide the discharging space, for preventing crosstalk with an adjacent discharging cell and a fluorescent substance 26 which is excited by vacuum ultraviolet rays on the surface of formed on the lower dielectric layer 28, for generating visible rays such as red, green and blue colors.

Also, a space between the upper and lower substrates of the plasma display panel is filled with discharging gas. The discharging gas forms buffer gas with He, Ne, Ar or the mixed gas and small amount of Xe gas is used by mixing as a source of vacuum ultraviolet ray for having the fluorescent substance emit light.

Therefore, the discharging cell of the PDP maintains discharging state by surface discharging among sustain electrodes 24 after being selected by opposite discharging between the address electrode 29 and sustain electrode 24.

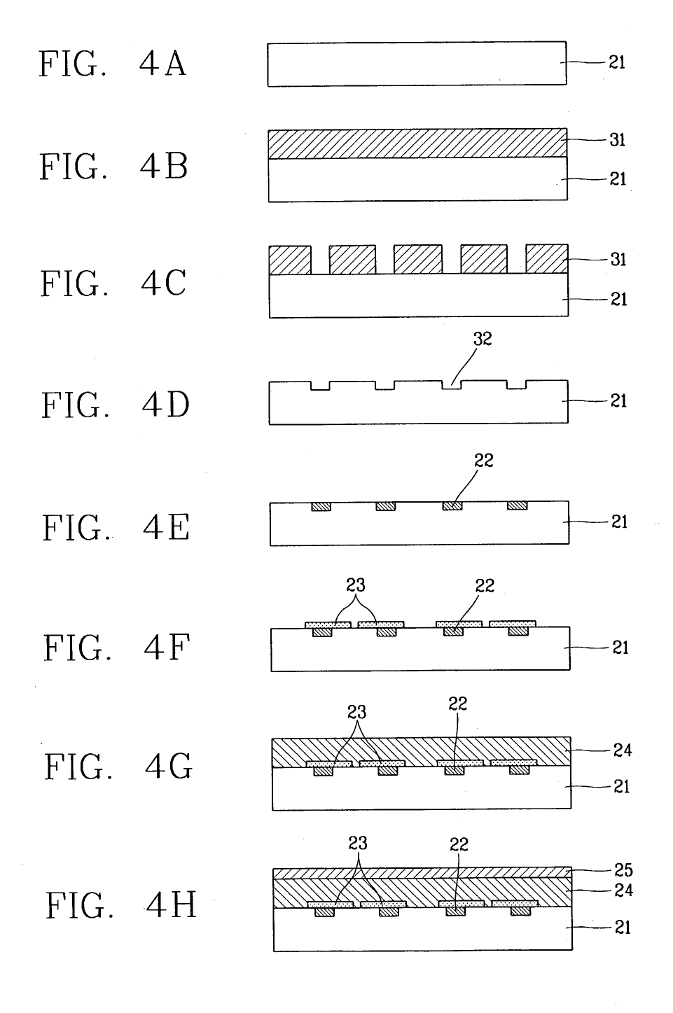

FIGS. 4A to 4h are views sequentially showing a method for fabricating an upper substrate of the PDP in accordance with the embodiment of the present invention.

Firstly, as shown in FIG. 4B, photoresist 31 is formed on an upper glass substrate of FIG. 4A. At this time, the photoresist 31 is formed using a dry film photoresist laminating method, or roll coating method. Then, a pattern mask is aligned on the upper substrate, and as shown in FIG. 4C, the photoresist 31 is patterned by using the photolithography process including exposing and developing processes.

When the photoresist 31 is patterned, as shown in FIG. 4D, a bus electrode forming groove 32 is patterned on the upper substrate using a sandblast method by the formed photoresist method, chemical etching method, plasma etching method and the like. At this time, the depth of the groove 32 is formed as 5 to 10 μm.

When the bus forming groove 32 is patterned, conductive materials composed of Cr/Cu/Cr or Ag is inserted in the bus forming groove 32, and accordingly the bus electrode 22 is formed as shown in FIG. 4E. Such bus electrode 22 is formed with conductive materials composed of Cr/Cu/Cr or Ag by a pattern printing method or exposing method using an Ag conductive material of DC202 optical image of DuPont Fodel (registered trademark).

When the bus electrode 22 is formed, as shown in FIG. 4F, sustain electrodes 23 which are formed in a pixel as a pair, for maintaining light emission of the pixel by mutual discharging of the electrodes are formed on the upper glass substrate 21.

Such sustain electrode 23 is formed by patterning by a photolithography method including anisotropic etching, after depositing Indium-Tin-Oxide, Indium- zinc-Oxide or Indium-Tin-Zinc-Oxide which is a transparent conductive substance on the front surface of the upper glass substrate 21. At this time, the sustain electrode 23 is patterned so that the bus electrode 22 is positioned at the edge thereof.

When the sustain electrode 23 and bus electrode 22 are formed, as shown in FIG. 4G, the upper dielectric layer 24 is formed on the front surface of the glass substrate 21. Such upper dielectric layer 24 is applied by the screen printing method having SiO2 and PbO as the main substances. Then, the protection layer 25 is formed on the dielectric layer 24. At this time, the protection layer 25 is formed by depositing MgO at about 5000 Å.

As described above, in the PDP in accordance with the present invention, the bus electrode and dielectric layer are not directly contacted to each other by inserting the bus electrode formed in the upper dielectric layer on the upper glass substrate. Accordingly, electro migration is not generated and transmissivity of the upper substrate can be improved. Also, since the electro migration is not generated, there is no need to form an Ag diffusion preventing dielectric layer in case of forming a dielectric layer, and the number of processes and the cost can be reduced. Also, since the bus electrode is inserted in the upper glass substrate, a breakdown phenomenon that the current is rapidly increased can be prevented, and accordingly thickness of the dielectric layer can be decreased, thus to improve transmissivity, reduce the cost, and reduce the discharging voltage.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A plasma display panel comprises an upper glass substrate which forms two grooves in each discharging cell and bus electrodes are inserted in the grooves.

2. The panel of claim 1, wherein the bus electrodes are composed of conductive materials made of metal alloys of Cr/Cu/Cr, or Ag.

3. The panel of claim 1, wherein the thickness of the groove is from 5 μm to 10 μm.

4. The panel of claim 1, further comprising:
a sustain electrode which is formed with transparent conductive materials to cover the bus electrodes in the upper glass substrate, for causing discharging;
a dielectric layer which is formed on the upper glass substrate to cover the sustain electrode; and
a protection layer which is formed in the upper portion of the dielectric layer.

5. The panel of claim 4, wherein the bus electrodes are formed at an edge of the sustain electrode to have long gaps.

6. A plasma display panel, comprising:
an upper glass substrate having two grooves in each unit discharging cell;
bus electrodes which are inserted in grooves which are formed on the upper glass substrate;
a sustain electrode which is formed with transparent conductive materials to cover the bus electrodes on the upper glass substrate, for causing discharging;
a dielectric electrode which is formed in the upper glass substrate to cover the sustain electrode; and
a protection layer which is formed in the upper portion of the dielectric layer.

7. The panel of claim 6, wherein the sustain electrode is composed of Indium-Tin-Oxide, Indium-Zinc-Oxide or Indium-Tin-Zinc-Oxide in due consideration of its transmissivity.

8. The panel of claim 6, wherein the dielectric layer of series of SiO₂ and PbO is applied to limit a current by forming capacitance.

9. The panel of claim 6, wherein the protection layer is formed by depositing MgO on the surface of the dielectric layer.

10. The panel of claim 6, further comprising:
an address electrode which is formed on the lower glass substrate which faces with the upper substrate centering a discharging space and is crossing to the sustain electrode;
a lower dielectric layer which is formed on the upper front surface of the address electrode;
a barrier rib which is formed between the upper substrate and the lower dielectric layer, for dividing the discharging space; and
a fluorescent substance which is formed on the barrier rib and the lower dielectric layer, for emitting light by ultraviolet rays.

11. The panel of claim 10, wherein the discharging space includes buffer gas which is composed of He, Ne, Ar or their mixture gas, and discharging gas in which small amount of Xe gas is mixed as a source of vacuum ultraviolet rays for having the fluorescent substance emit light.

12. A method for fabricating a plasma display panel, comprising the steps of:
forming a predetermined photoresist pattern on an upper glass substrate;
forming a groove on the upper glass substrate by the photoresist pattern;
forming a bus electrode to be inserted in the groove formed on the upper glass substrate;
forming a sustain electrode which is formed to cover the bus electrode, for causing dielectric layer;
forming a dielectric layer on the front surface of the upper glass substrate and calcining the substrate; and
forming a protection layer on the dielectric layer.

13. The method of claim 12, wherein the bus electrode is positioned between the upper glass substrate and the sustain electrode not to be directly contacted on the dielectric layer in the step of forming the bus electrode.

14. The method of claim 12, wherein the step of forming the photoresist pattern includes the steps of:
applying photoresist on the front surface by one of a dry film resist laminating method or a rolling coating method; and
patterning the photoresist using a photolithography process including exposing and developing processes.

15. The method of claim 12, wherein the substrate is patterned using one among a sand blast, chemical etching or plasma etching method by the photoresist pattern in the step of forming a groove.

16. The method of claim 15, wherein the thickness of the patterned groove is from 5 μm to 10 μm.

17. The panel of claim 12, wherein conductive materials composed of metal alloys of Cr/Cu/Cr, or Ag are inserted in the groove on the substrate by a pattern printing method, or an exposure method using FODEL in the step of forming the bus electrodes.

18. The panel of claim 12, wherein the sustain electrode is formed by patterning by a photolithography method including anisotropic etching, after depositing Indium-Tin-Oxide, Indium-Zinc-Oxide or Indium-Tin-Zinc-Oxide which is a transparent conductive substance on the front surface of the upper substrate, in the step of forming the sustain electrode.

19. The panel of claim 12, wherein materials having SiO2 and PbO as the main substances are applied on the dielectric layer by a screen printing method.

20. The panel of claim 12, wherein the protection layer is formed by depositing MgO at about 5000 Å.
